(19) United States
(12) Patent Application Publication
(10) Pub. No.: US 2026/0277220 A1
(43) Pub. Date: Sep. 17, 2026

(54) MEASURED FUSELAGE PITCH-BASED CONTROL SURFACE ADJUSTMENTS

(71) Applicant: Toyota Motor Engineering & Manufacturing North America, Inc., Plano, TX (US)

(72) Inventors: Tom M. Neuman, Fairfax, VA (US); Frank K. Kozel, Glen Burnie, MD (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/395,269

(22) Filed: Nov. 20, 2025

Related U.S. Application Data
(60) Provisional application No. 63/770,538, filed on Mar. 12, 2025.

(51) Int. Cl. G05D 1/49; B64C 3/38; G05D 109/22

(52) U.S. Cl. CPC G05D 1/49; B64C 3/385; G05D 2109/22

(57) ABSTRACT

Systems, methods, and other embodiments described herein relate to improving lift and efficiency in an aircraft by adjusting the pitch of a fuselage in a free-wing aircraft. In one embodiment, a method includes determining, based on an input objective, a target fuselage pitch for a fuselage of an aircraft. A wing assembly of the aircraft rotates about a pitch axis of the aircraft independently from the fuselage. The method also includes measuring a fuselage pitch of the fuselage. The method also includes altering an angle of a control surface of the aircraft based on a difference between the target fuselage pitch and the fuselage pitch.

### CROSS-REFERENCE TO RELATED APPLICATIONS

This application claims the benefit of U.S. Provisional Application No. 63/770,538, filed on Mar. 12, 2025, which is herein incorporated by reference in its entirety.

### TECHNICAL FIELD

The subject matter described herein relates, in general, to free-wing aircraft and, more particularly, to adjusting the angle of a control surface of the free-wing aircraft based on a target pitch for a fuselage of the aircraft.

### BACKGROUND

In an airplane, lift is created as air travels over the wing while the airplane moves forward. Specifically, air over the top curved surface of the wing travels more quickly and creates lower pressure, while air below the bottom surface of the wing moves more slowly, creating a higher pressure. This pressure differential generates an upward force known as lift.

Free-wing aircraft have wings that freely pivot about a pitch axis of the aircraft independently from the fuselage of the aircraft. The wings are connected to the fuselage via bearings or bushings that pivot freely, i.e., with minimal mechanical friction or damping, in pitch. All other degrees of freedom (roll, yaw, heave, sway, surge) may be rigidly connected between the fuselage and wing. Propellers, or another thrust source, may be attached to the wings to drive the aircraft. These aircraft may exhibit enhanced maneuverability and facilitate unique flying motions, such as vertical and horizontal flight modes.

### SUMMARY

In one embodiment, example systems and methods relate to a manner of improving the lift and efficiency of a free-wing aircraft. In one embodiment, a control surface control system is disclosed. The control surface control system includes a processor and a memory storing machine-readable instructions that, when executed by the processor, cause the processor to determine, based on an input objective, a target fuselage pitch for a fuselage of an aircraft. The wing assembly of the aircraft rotates about a pitch axis of the aircraft independently from the fuselage. The memory also stores machine-readable instructions that, when executed by the processor, cause the processor to measure a fuselage pitch of the fuselage. The memory also stores machine-readable instructions that, when executed by the processor, cause the processor to alter an angle of a control surface of the fuselage based on a difference between the target fuselage pitch and the fuselage pitch.

In one embodiment, a non-transitory machine-readable medium is disclosed. The non-transitory machine-readable medium includes instructions that, when executed by the processor, cause the processor to determine, based on an input objective, a target fuselage pitch for a fuselage of an aircraft. The wing assembly of the aircraft rotates about a pitch axis of the aircraft independently from the fuselage. The medium also includes instructions that, when executed by the processor, cause the processor to measure a fuselage pitch of the fuselage. The medium also includes instructions that, when executed by the processor, cause the processor to alter an angle of a control surface of the fuselage based on a difference between the target fuselage pitch and the fuselage pitch.

In one embodiment, a method for improving the lift and efficiency of a free-wing aircraft is disclosed. In one embodiment, the method includes determining, based on an input objective, a target fuselage pitch for a fuselage of an aircraft. The wing assembly of the aircraft rotates about a pitch axis of the aircraft independently from the fuselage. The method also includes measuring a fuselage pitch of the fuselage. The method also includes altering an angle of a control surface of the fuselage based on a difference between the target fuselage pitch and the fuselage pitch.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of an aircraft within which systems and methods disclosed herein may be implemented.

FIG. 2 illustrates one embodiment of a control surface control system that is associated with altering the angle of a control surface, according to an embodiment of the principles described herein.

FIG. 3 illustrates a flowchart for one embodiment of a method that is associated with altering the angle of a control surface, according to an embodiment of the principles described herein.

FIG. 4 is a side view of an aircraft with an aligned wing assembly pitch and fuselage pitch, according to an embodiment of the principles described herein.

FIGS. 5A-5B are side views of an aircraft with the fuselage pitched up to match an upwardly-pitched wing assembly, according to an embodiment of the principles described herein.

FIG. 6A-6B are side views of an aircraft with the fuselage pitched up to match a wing assembly pitch, according to an embodiment of the principles described herein.

FIGS. 7A-7B are side views of an aircraft with the fuselage pitched down to match a downwardly-pitched wing assembly, according to an embodiment of the principles described herein.

FIG. 8A-8B are side views of an aircraft with the fuselage pitched down to match a wing assembly pitch, according to an embodiment of the principles described herein.

FIG. 9 is a side view of an aircraft where the fuselage and wing assembly are upwardly pitched to different degrees, according to an embodiment of the principles described herein.

FIG. 10 is a side view of an aircraft where the fuselage and wing assembly are downwardly pitched to different degrees, according to an embodiment of the principles described herein.

FIG. 11 depicts a control loop that aligns the fuselage pitch with a wing assembly pitch, according to an embodiment of the principles described herein.

FIG. 12 depicts a control loop that aligns the fuselage pitch with a predetermined pitch, according to an embodiment of the principles described herein.

FIG. 13 depicts a control loop that adjusts the fuselage pitch towards a wing assembly pitch, according to an embodiment of the principles described herein.

FIG. 14 depicts a control loop that adjusts the fuselage pitch to achieve a target energy consumption, according to an embodiment of the principles described herein.

FIG. 15 depicts a control loop that aligns the fuselage pitch with a predetermined pitch, according to an embodiment of the principles described herein.

### DETAILED DESCRIPTION

Systems, methods, and other embodiments associated with improving the lift and efficiency of a free-wing aircraft, in which the wing assembly freely rotates about the pitch axis independently from the fuselage

The aircraft may include control surfaces to manipulate the aircraft attitude (i.e., pitch, roll, and yaw) during flight. In general, a control surface manipulates airflow to generate aerodynamic forces that change the aircraft direction and/or attitude (e.g., pitch, yaw, and roll). For example, as a pilot, whether onboard the aircraft or from a remote location, inputs a control command at a control yoke, control stick, remote control joystick, or the like, a controller deflects the control surfaces to alter the direction of air and generate forces that move the aircraft. There are various control surfaces, such as elevators, ailerons, rudders, flaps, spoilers, stabilators, elevators, elevons, trim tabs, and canards.

In a free-wing aircraft where the fuselage pitch and the wing assembly pitch are independent from one another, it may be that the fuselage pitch is not actively controlled in flight and may be different from the wing assembly pitch. The pitch of the fuselage may be defined by the loading (i.e., center of gravity in front of the wing assembly pitch axis or behind the wing assembly pitch axis). Given that 1) fuselage pitch has a bearing on the lift or efficiency of the aircraft and 2) the fuselage pitch is uncontrolled, a fuselage pitch may decrease the overall aircraft lift or efficiency. For example, if the fuselage is nose-heavy, the fuselage may stabilize in a pitched downward position (i.e., the fuselage nose is pitched downward from a reference horizon angle). This may decrease the overall lift and increase the overall drag of the aircraft. This may result in reduced fuel and operational efficiency and may require elevated air speeds to operate the aircraft as desired.

By comparison, if the fuselage is tail-heavy, the fuselage may stabilize in a pitched upward position (i.e., the fuselage nose is pitched upward from a reference horizon angle). This may increase the overall lift and drag of the aircraft. As described above, increased drag reduces the fuel and operational efficiency of the aircraft. While an increased lift may be desirable in some flight conditions, such as low speed or banking flight, lift resulting from an uncontrolled variable in the flight conditions (i.e., the fuselage pitch) may lead to the aircraft flying differently than the pilot anticipated. In summary, operating conditions where the fuselage pitch is different than the wing assembly pitch may negatively impact the lift generated by the aircraft and/or the efficiency of the flight operations of the aircraft.

Accordingly, the present specification describes a system that improves the lift and/or efficiency of a free-wing aircraft by controlling the pitch of the free fuselage. Specifically, the system determines the wing assembly pitch and the fuselage pitch and moves a fuselage control surface, such as the stabilator or elevator, to maintain a desired pitch for the fuselage based on the wing assembly pitch or another input objective. That is, altering the fuselage control surface changes the pitch of the fuselage to a target value.

The target fuselage pitch may be determined in a variety of ways. In one example, the target fuselage pitch is equal to the wing assembly pitch. That is, the system may deflect control surfaces on the fuselage to generate aerodynamic forces that align the fuselage pitch with the wing assembly pitch. It should be noted, however, that the fuselage pitch being level to (i.e., matching) the wing assembly pitch may not always be the target configuration. Other example target configurations include 1) maintaining the fuselage at a fixed pitch which is level to the earth’s surface, 2) pitching the fuselage pitch higher/lower than the wing assembly pitch, 3) controlling the fuselage pitch to actively minimize energy consumption (e.g., battery current or fuel flow), and 4) controlling the fuselage pitch to increase lift in low speed flight.

There may be other reasons why it may be desirable to set the fuselage pitch to a value different from the wing assembly pitch. For example, the wing angle of attack and its total lift may be limited by aerodynamic stall. The fuselage, however, may sustain much higher angles of attack before loss of lift. Accordingly, a fuselage with a higher angle of attack may increase the overall lift of the aircraft, albeit with reduced overall efficiency, without increasing the risk of an aerodynamic stall. This may be acceptable when flying the aircraft at low speeds or high bank angles. As another example, it may be helpful to increase the drag of the aircraft to decelerate without the use of spoilers. The present system may, therefore, determine a desired fuselage pitch and alter the control surface to achieve the desired pitch angle.

In an example, the control surfaces may be managed by a flight controller, the flight controller may be switchable between modes, where each mode deflects the control surfaces to achieve a desired objective. For example, the flight controller may switch between 1) a mode for minimizing energy consumption, 2) a mode for holding the fuselage level to the wing regardless of energy consumption, and 3) a mode for increasing lift in low-speed flight at the cost of efficiency, etc. Each mode may trigger different fuselage pitches relative to the wing assembly pitch. As such, the present control surface control system increases the lift and fuel/operational efficiency of aircraft where the wing assemblies of the aircraft rotate independently from the fuselage about a pitch axis (e.g., a free-wing aircraft) by changing the deflection of various control surfaces to set the fuselage pitch to a target value, which target value may be defined by the wing assembly pitch, or some other target objective.

As computational fluid dynamics (CFD) analysis indicates that the overall aircraft drag can increase by as much as 5% for every degree that the fuselage pitch is below the wing assembly pitch angle, the system of the present specification may be able to increase the aircraft flight range by 10% or more. This improvement is enhanced when aircraft operators load the fuselage with a large center of gravity range, which may cause the fuselage to pitch high or low for the entire flight if some means of compensation is not included.

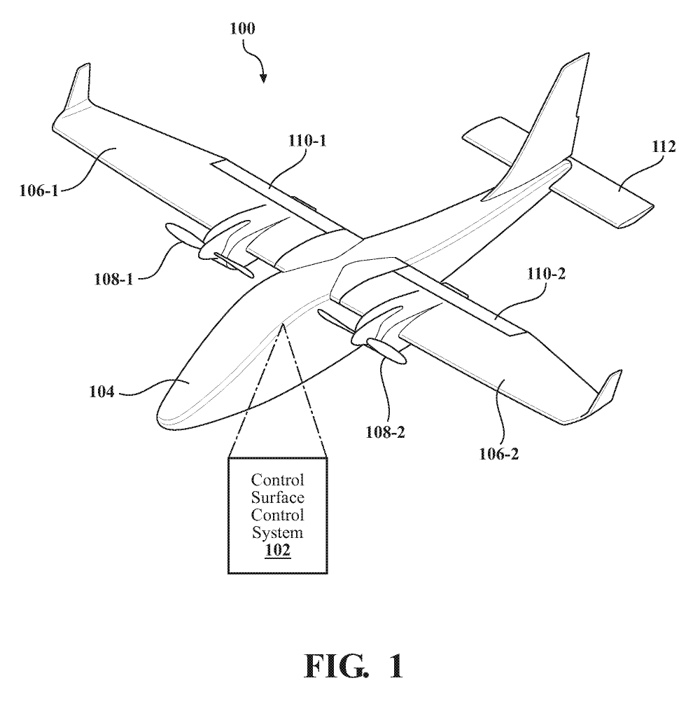

Turning now to the figures, FIG. 1 illustrates one embodiment of an aircraft 100 within which systems and methods disclosed herein may be implemented. It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the aircraft 100 includes a control surface control system 102 that is implemented to perform methods and other functions as disclosed herein relating to enhancing the lift and efficiency of an aircraft via control surface alterations.

In general, the aircraft 100 includes a fuselage 104, or body, in which mechanical, electrical, and/or control systems are housed. As described above, the aircraft 100 may have a variety of uses, and the flight control components specific to the particular use may be housed within the fuselage 104. As a particular example, the aircraft 100 may be unmanned. In this case, the fuselage 104 houses a communication system for receiving and executing commands from a remote operator. In another example, the aircraft 100 is locally operated by a pilot on board the aircraft 100. In this example, the fuselage 104 includes a cockpit where the pilot sits to control the aircraft 100.

The aircraft 100 also includes a pair of wings 106-1 and 106-2 extending away from the fuselage 104. The wings 106-1 and 106-2 in combination may be referred to as a wing assembly. In one specific example, the aircraft 100 is a free-wing aircraft in which the wing assembly (including both wings 106-1 and 106-2) freely rotates independently about a pitch axis of the fuselage 104 of the aircraft 100. In this example, the wings 106-1 and 106-2 and fuselage 104 are coupled together via bearings or bushings that pivot freely, i.e., with minimal mechanical friction or damping, in pitch. In one example, the wings 106-1 and 106-2 of a free-wing aircraft are rigidly coupled to one another such that the entire wing assembly rotates as a single unit independently of the fuselage 104. In another example, each wing 106-1 and 106-2 is independently rotatable about the pitch axis relative to the other wing and the fuselage 104.

The aircraft 100 also includes thrusters, which in the example depicted in FIG. 1, are propellers 108-1 and 108-2 mounted to respective wings 106-1 and 106-2. A thruster is any device or engine that generates thrust to move or control the aircraft 100. While FIG. 1 depicts propellers 108-1 and 108-2 as the thrusters, the aircraft 100 may include different kinds of thrusters, such as jet engines and ducted fans, among others.

As described above, the aircraft 100 may include any number of control surfaces. For example, the aircraft 100 may include elevons 110-1 and 110-2 on respective wings 106-1 and 106-2. Elevons combine the functions of an elevator and an aileron for pitch and roll control, respectively. As another example, the aircraft 100 may include a stabilator 112 on the tail of the aircraft 100.

The control surfaces change the airflow around the aircraft 100. Changes in the airflow around the aircraft 100 generate aerodynamic forces that move the aircraft 100 during flight. That is, when a pilot issues a flight command, these control surfaces deflect and alter the aircraft-guiding aerodynamic forces to change the attitude of the aircraft 100 to follow the pilot’s command. For example, in a fixed-wing aircraft, a pilot may pull backward on a control yoke to initiate a climb. Responsive to this input, the stabilator 112 or elevator deflects upward, generating a downward force on the tail of the aircraft. The downward force on the tail pitches the nose of the fixed-wing aircraft up.

In a free-wing aircraft, deflecting the elevator or stabilator 112 up generates a downward force on the tail of the fuselage 104. The downward tail force pitches the nose of the fuselage 104 upward. Note that as the wing assembly rotates freely from the fuselage 104, any alteration of the free-wing aircraft fuselage pitch (i.e., via a deflection of the stabilator 112, elevator, or other pitch-altering control surface) may not impact the pitch of the wing assembly. Instead, the wing assembly pitch may be adjusted by altering the elevon 110-1 and 110-2 positions.

In general, the control surface control system 102 adjusts the fuselage 104 pitch by adjusting the angle of a control surface. Specifically, as described in more detail below, the control surface control system 102 determines a target fuselage pitch (whether based on a wing assembly pitch or a specific target objective such as reduced fuel consumption, reduced drag, etc.) and alters the position of the control surface to set the fuselage 104 to the target fuselage pitch. As such, the fuselage pitch may be controlled by moving an entire stabilator 112, or a rear portion of a horizontal stabilizer referred to as an elevator, or a trim tab. Note that while FIG. 1 depicts elevons 110-1 and 110-2 and a stabilator 112, the aircraft 100 may include other types of control surfaces such as canards, trim tabs, spoilers, and a rudder. Accordingly, while FIG. 1 and others depict a stabilator 112 as the deflected control surface on the fuselage, the control surface control system 102 may adjust the deflection of any control surfaces that change the pitch of the fuselage 104.

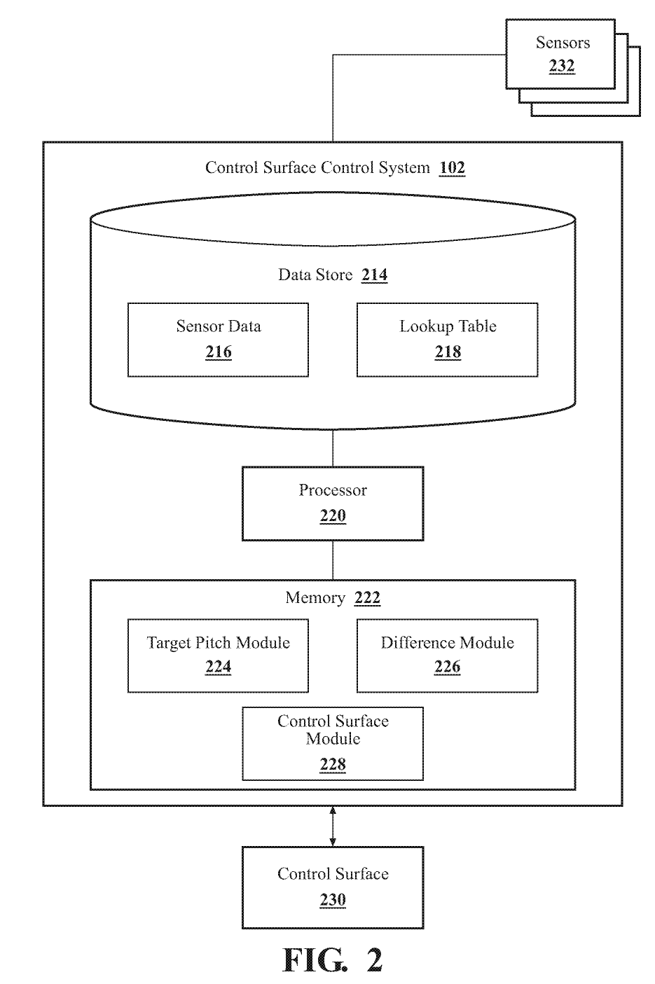

FIG. 2 illustrates one embodiment of a control surface control system 102 that is associated with altering the angle of a control surface 230, according to an embodiment of the principles described herein. As depicted in FIG. 2, the control surface control system 102 may include a processor 220. In one or more arrangements, the processor(s) 220 can be a primary/centralized processor of the aircraft 100 or may be representative of many distributed processing units. For instance, the processor(s) 220 can be an electronic control unit (ECU). Alternatively, or additionally, the processors include a central processing unit (CPU), an application-specific integrated circuit (ASIC), a microcontroller, a system on a chip (SoC), and/or other electronic processing units that support operation of the aircraft 100.

In one embodiment, the control surface control system 102 includes a memory 222 that stores a target pitch module 224, a difference module 226, and a control surface module 228. The memory 222 may be a random-access memory (RAM), read-only memory (ROM), a hard-disk drive, a flash memory, or another suitable memory for storing the modules 224, 226, and 228. The modules 224, 226, and 228 may be, for example, machine-readable instructions that, when executed by the processor 220, cause the processor 220 to perform the various functions disclosed herein. In alternative arrangements, the modules 224, 226, and 228 are independent elements from the memory 222 that are, for example, comprised of hardware elements. Thus, the modules 224, 226, and 228 are alternatively ASICs, hardware-based controllers, a composition of logic gates, or another hardware-based solution.

The aircraft 100 may include one or more data stores 214 for storing one or more types of data. In general, the data store 214 is, in one embodiment, an electronic data structure stored in the memory 222 or another data storage device and that is configured with routines that can be executed by the processor 220 for analyzing stored data, providing stored data, organizing stored data, and so on. Thus, in one embodiment, the data store 214 stores data used by the modules 224, 226, and 228 in executing various functions. The data store 214 can be comprised of volatile and/or non-volatile memory. Examples of memory that may form the data store 214 include RAM, flash memory, ROM, PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 214 is a component of the processor(s) 220. In general, the data store 214 is operatively connected to the processor(s) 220 for use thereby. The term "operatively connected," as used throughout this description, can include direct or indirect connections, including connections without direct physical contact.

In one embodiment, the data store 214 stores the sensor data 216 relied on by the modules 224, 226, and 228. That is, the amount of control surface adjustment may be based on any number of conditions, such as the fuselage pitch, the wing assembly pitch, the current control surface deflection/angular position, and an input objective. Accordingly, the sensor data 216 may include data indicative of at least the fuselage pitch, the wing assembly pitch, the current control surface deflection/angular position, and/or data associated with an input objective.

In an example, the control surface deflection is triggered by and based on the fuselage pitch. Moreover, control surface deflection may be terminated once the fuselage reaches a target fuselage pitch. Accordingly, the aircraft 100 may include sensors 232 that detect the fuselage pitch. Examples of fuselage pitch sensors include an attitude indicator (e.g., an artificial horizon), a gyroscope, an accelerometer, and/or an inertial measurement unit (IMU), among other pitch sensors.

Similarly, the control surface deflection may be triggered by and based on the wing assembly pitch. Specifically, control surface deflection may be triggered when the fuselage pitch differs from the wing assembly pitch. Similarly, control surface deflection may be terminated once the fuselage pitch 1) matches the wing assembly pitch or 2) is within a predetermined range from the wing assembly pitch. Accordingly, the aircraft 100 may include sensors 232 that detect the wing assembly pitch. Examples of wing assembly pitch sensors include a gyroscope, an accelerometer, and/or an IMU, among other pitch sensors.

In an example, the control surface deflection is based on the current control surface position. In this example, the aircraft 100 includes sensors 232, some of which measure the deflection of the various control surfaces. Accordingly, the sensor data 216 may include data from sensors 232 that measure the deflection/angular position of the control surfaces. Examples of control surface deflection-measuring sensors include a rotary variable differential transformer (RVDT) that measures a rotational displacement, a linear variable differential transformer (LVDT) that measures linear displacement, a potentiometer, an optical or magnetic encoder to track the position of the control surface, and/or a strain gauge, among other deflection sensors.

In another example, the target fuselage pitch is determined not by a wing assembly pitch, but by some other input objective, such as a target energy consumption (e.g., reducing fuel consumption), a target range (e.g., reducing the drag), or a target aerodynamic condition (e.g., maintaining lift at low speeds), etc. In some cases, the aircraft 100 may include any number of sensors 232 that sense information about the aircraft 100 itself, which sensors 232 may be used to evaluate compliance with the input objective. For example, where the objective is to reduce fuel consumption, the aircraft 100 may include sensors 232 that measure fuel levels, or fuel usage of the aircraft 100. In another example, where the objective is to reduce battery consumption, the aircraft 100 may include sensors 232 that measure battery levels or electrical consumption of the aircraft 100.

Other examples of sensors 232 that may indicate a state of the aircraft include altitude sensors, air speed sensors, air humidity sensors, air density sensors, etc. In summary, the aircraft 100 may include any number of sensors 232 that measure different characteristics of the aircraft 100 and/or the flight conditions of the aircraft 100. The sensor data 216 may include data from these sensors 232. Note that while particular reference is made to particular sensors 232 and particular sensor data 216, the aircraft 100 may include different sensors 232, and the data store 214 may store other sensor data 216, usable by the modules 224, 226, and 228 to guide control surface deflection in a free-wing aircraft 100 towards a target value.

The data store 214 may store the sensor data 216 along with, for example, metadata that characterizes various aspects of the sensor data 216. For example, the metadata can include location coordinates (e.g., longitude and latitude), relative map coordinates or tile identifiers, time/date stamps from when the separate sensor data 216 was generated, and so on.

In one embodiment, the data store 214 further includes a lookup table 218. In some cases, a control surface adjustment may be determined in real-time based on the sensor data 216. For example, the control surface may be adjusted until the fuselage pitch matches the wing assembly pitch. Accordingly, in this example, the target pitch module 224 may adjust the control surface until sensor data 216 from fuselage pitch sensors and wing assembly pitch sensors align. As another example, it may be that the control surface is to be adjusted so that there is a predetermined difference between the fuselage pitch and the wing assembly pitch. In this example, the predetermined difference may be encoded within the memory 222 or data store 214, and the target pitch module 224 may adjust the control surface 230 until the sensor data 216 from pitch sensors of the aircraft 100 indicates that the measured difference matches the predetermined difference.

However, in other cases, the control surface adjustment determination may be supplemented by information in the lookup table 218. For example, the lookup table 218 may map a detected difference between a measured fuselage pitch and a target fuselage pitch to an amount of deflection. For example, it may be that the fuselage pitch is intended to have a predetermined difference from the wing assembly pitch. That is, in this case, rather than having the fuselage pitch match the wing assembly pitch, it may be desirable for the two pitches to be different to achieve some specific objective. In this case, the lookup table 218 may map the target difference to an amount of control surface deflection. For example, it may be desirable to set the fuselage pitch to an amount that is 5% greater than the wing assembly pitch. In this example, sensor data 216 may indicate that a wing assembly has a pitch of 15 degrees. Based on this information and relying on the lookup table 218, the target pitch module 224 may determine the amount of control surface 230 deflection to set the fuselage pitch to an amount that is 5% greater than the 15-degree pitch of the wing assembly.

While the above example describes a specific example where the lookup table 218 maps the control surface angle adjustments to a detected difference between the fuselage pitch and the wing assembly pitch, the lookup table 218 may map the control surface angle adjustment to other detected differences such as a difference between the measured fuselage pitch and any one of 1) a fixed value fuselage pitch, 2) a target pitch that is a predetermined amount different than the wing assembly pitch, and/or 3) a target pitch defined by an objective (e.g., reduced fuel consumption, reduced drag, etc.).

In an example, the lookup table 218 may also be indexed by various flight conditions that may have an impact on the detected difference and/or the control surface adjustments needed to effectuate a desired pitch change. For example, variables such as air speed, altitude, aircraft weight, center of gravity, humidity, air density, etc., may all affect the aerodynamic control capability of a control surface 230. As such, the lookup table 218 may be indexed by these variables so that a control surface 230 adjustment that achieves the desired fuselage pitch change may be effectuated.

As yet another example, the lookup table 218 may map various flight conditions to a target fuselage pitch. For example, the lookup table 218 may map various measurable factors, such as airspeed, altitude, wing assembly pitch, and uncompensated fuselage attitude, to a target fuselage pitch that has been predetermined to achieve a particular objective, such as optimized lift and/or efficiency. Accordingly, in this example, rather than relying on wing assembly pitch sensor data 216, the control surface control system 102 may compare a measured fuselage to a lookup table-based target fuselage pitch.

As described previously, the aircraft 100 can include one or more modules 224, 226, and 228, at least some of which are described herein. In at least one arrangement, the modules 224, 226, and 228 are implemented as non-transitory machine-readable instructions that, when executed by the processor 220, implement one or more of the various functions described herein. In various arrangements, one or more of the modules 224, 226, and 228 are a component of the processor(s) 220, or one or more of the modules 224, 226, and 228 are executed on and/or distributed among other processing systems to which the processor(s) 220 is operatively connected. Alternatively, or in addition, the one or more modules 224, 226, and 228 are implemented, at least partially, within hardware. For example, the one or more modules 224, 226, and 228 may be comprised of a combination of logic gates (e.g., metal-oxide-semiconductor field-effect transistors (MOSFETs)) arranged to achieve the described functions, ASICs, programmable logic arrays (PLA), field-programmable gate arrays (FPGA), and/or other electronic hardware-based implementations to implement the described functions. Further, in one or more arrangements, one or more of the modules 224, 226, and 228 can be distributed among a plurality of the modules 224, 226, and 228 described herein. In one or more arrangements, two or more of the modules 224, 226, and 228 described herein can be combined into a single module.

The control surface control system 102 includes a target pitch module 224. In general, the target pitch module 224 includes instructions that cause the processor 220 to determine, based on an input objective, a target fuselage pitch for a fuselage 104 of the aircraft 100, which aircraft 100 as described above, has a wing assembly that freely rotates about a pitch axis of the aircraft 100 independently from the fuselage 104.

As described above, the input objective may vary, and the target fuselage pitch may be determined directly or indirectly from the input objective. For example, in some cases, a lift and operational efficiency of the aircraft 100 may be achieved when the fuselage pitch matches the wing assembly pitch. In this example, the input objective may be to have the fuselage pitch match the wing assembly pitch. As such, the target fuselage pitch may be the wing assembly pitch. Thus, the target pitch module 224 may extract sensor data 216 indicative of the wing assembly pitch and may include instructions that cause the processor 220 to determine the target fuselage pitch based on the wing assembly pitch (i.e., set the target fuselage pitch to the wing assembly pitch value).

In another example, lift and operational efficiency of the aircraft 100 may be achieved when the fuselage pitch is different than the wing assembly pitch. For example, a wing assembly may have an upper limit on how much it can pitch before a wing stall occurs. This may cap the lift that the wing assembly can generate. However, a pilot may desire more overall lift of the aircraft 100 than can be provided by the wing assembly without resulting in a wing stall. As the fuselage 104 pitch may not contribute to a stall state, the fuselage 104 may be pitched higher than the wing assembly to increase lift, without increasing the risk of wing stall. In this example, the target fuselage pitch may be the wing assembly pitch plus or minus some predetermined difference. Thus, the target pitch module 224 may extract sensor data 216 indicative of the wing assembly pitch when determining the target fuselage pitch and may set the target fuselage pitch as the wing assembly pitch plus or minus some amount.

In another example, the input objective may be to set the fuselage pitch to some predetermined fixed pitch. As such, the target fuselage pitch may be the predetermined fixed pitch.

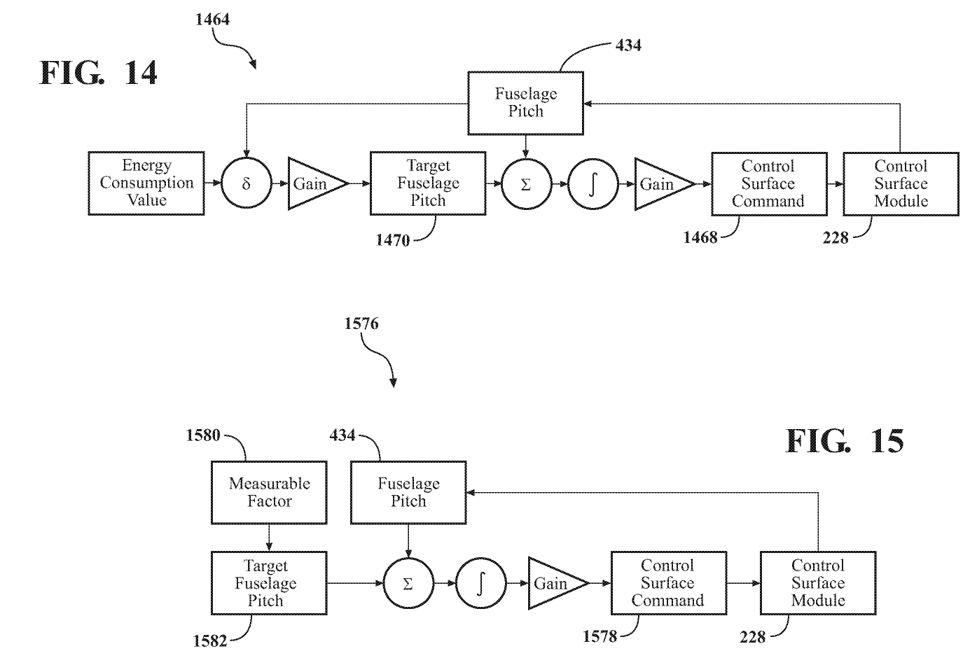

In other examples, the target fuselage pitch may be determined indirectly from the input objective. For example, a user may set the aircraft 100 to an economy mode where fuel consumption and/or battery consumption is to be minimized. To achieve the desired fuel economy or battery consumption level, it may be that the fuselage pitch should be set to a different value than the wing assembly pitch. In this example, the target fuselage pitch may be determined indirectly based on the input objective. That is, the target pitch module 224 may 1) monitor sensor data 216 that indicates fuel economy and 2) determine the target fuselage pitch based on the sensor data 216. In this example, the target fuselage pitch may be the fuselage pitch that results in fuel economy sensor data being maximized and/or fuel usage sensor data being minimized. An example of such a control loop is depicted below in connection with FIG. 14.

In an example, a pilot may be able to select between different modes for the flight, with different modes defining different input objectives. For example, a pilot may select an economy mode, where fuel and/or battery consumption is conserved, thereby maximizing flight endurance. In another example, a pilot may select a range mode, where flight range is maximized. In another example, a pilot may select a low-speed mode. In any of these examples, the control surface control system 102 includes instructions that cause the processor 220 to identify the input objective based on user selection from a set of candidate objectives. In some examples, a mode and its associated input objective may be selected via an input device on an aircraft controller. For example, in the case of a piloted aircraft, a pilot may select a mode via a button, switch, dial, or other input on a control panel or control yoke. In the example of a remotely-piloted aircraft, a pilot may select a mode via a button, switch, dial, touch pad, or other input on a remote control.

The control surface control system 102 may include a difference module 226 that includes instructions to determine a difference between the target and measured fuselage pitch. Thus, the difference module 226 may include instructions that cause the processor 220 to measure the fuselage pitch of the fuselage 104. Specifically, the difference module 226 may extract sensor data 216 indicative of the fuselage pitch. Given that the difference module 226 compares a detected fuselage pitch to the target fuselage pitch, as determined by the target pitch module 224, the difference module 226 may be operatively connected to, and receive the output from the target pitch module 224.

As described above, this target fuselage pitch may be a variety of values, including 1) the wing assembly pitch, 2) a fixed pitch value, 3) a predetermined difference from the wing assembly pitch, or 4) some other value calculated based on an input objective. Accordingly, in this example, the difference module 226 may compare the measured fuselage pitch (via the sensor data 216 indicative of fuselage pitch) with one or more of the 1) wing assembly pitch (via sensor data 216 indicative of wing assemby pitch), 2) a fixed pitch value (as recorded in the memory 222 or data store 214), 3) a target pitch that is a predetermined amount different than the wing assembly pitch (as calculated by the target pitch module 224), and/or 4) an input objective-calculated target pitch (as calculated by the target pitch module 224).

In the specific example where the target fuselage pitch is based on the wing assembly pitch, the difference module 226 may include instructions that cause the processor 220 to measure the wing assembly pitch and detect a difference between the fuselage pitch and the wing assembly pitch. In any of these examples, detecting the difference between the target and measured fuselage pitches may include comparing numeric values.

The control surface control system 102 may further include a control surface module 228 that includes instructions that cause the processor 220 to alter an angle of a control surface 230 of the fuselage 104 based on a difference between the target fuselage pitch and the fuselage pitch as measured by the sensors 232. Accordingly, the control surface module 228 may be operatively connected to, and receive the output from, the target pitch module 224 and the difference module 226. In other words, the control surface module 228 may generate a signal that instructs a control surface 230 or a controller of the control surface 230, whatever type of control surface 230 that may be, to change position to alter the pitch of the fuselage 104 such that the fuselage pitch matches the target fuselage ptich.

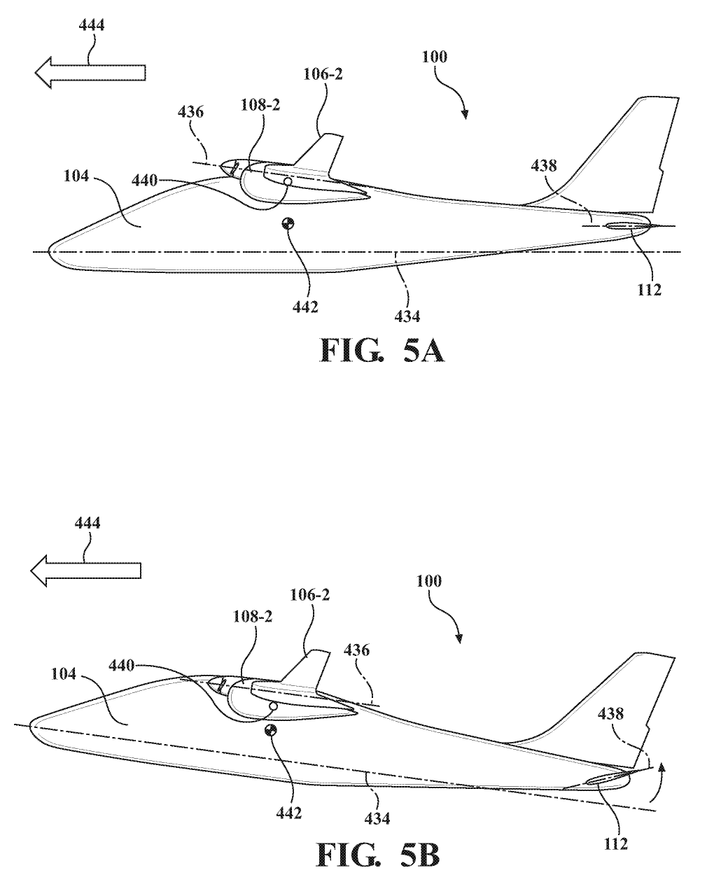

As described above, the alteration may be based on 1) the difference between a fuselage pitch and a wing assembly pitch, 2) the difference between a fuselage pitch and some predetermined fixed pitch value, 3) the difference between the fuselage pitch and a predetermined offset from the wing assembly pitch, or 4) a difference between the fuselage pitch and some target fiselage pitch calculated based on an input objective. FIGS. 5A – 8B depict various control surface operations that may be implemented based on a detected difference between a fuselage pitch and a wing assembly pitch.

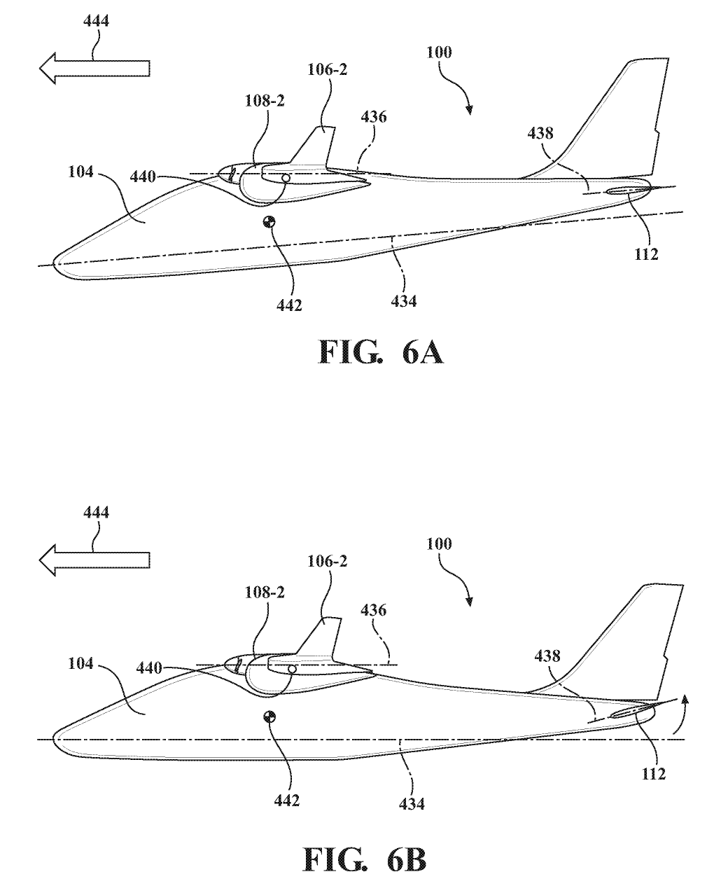

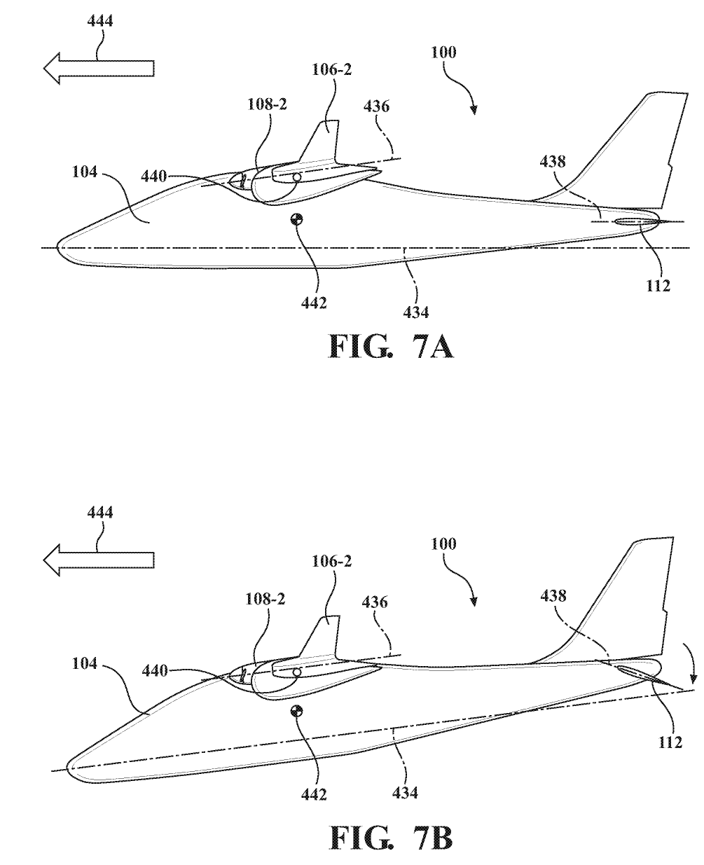

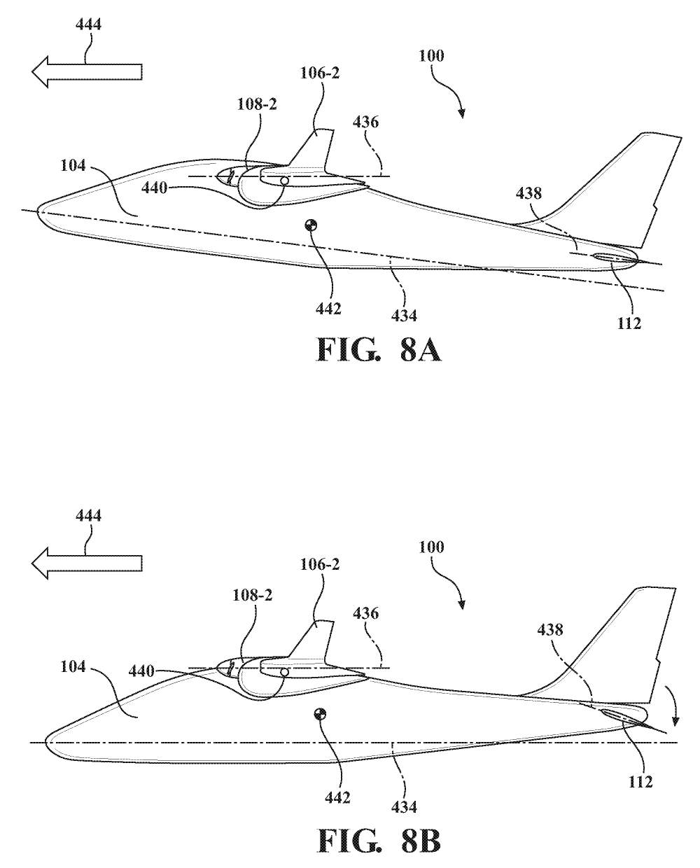

For example, as depicted in FIGS. 5A and 5B, the difference module 226 may determine that a wing assembly pitch is more positive (upward) than the fuselage pitch. In this example, the control surface module 228 may deflect the trailing edge of the stabilator 112, or other control surface 230, upward to alter the fuselage 104 pitch toward the wing assembly pitch. As depicted in FIGS. 6A and 6B, the difference module 226 may determine that a fuselage pitch is more negative (downward) than a wing assembly that is level. In this example, the control surface module 228 may deflect the trailing edge of the stabilator 112, or other control surface 230, upward to alter the fuselage 104 pitch toward the level wing assembly pitch. As depicted in FIGS. 7A and 7B, the difference module 226 may determine that a wing assembly pitch is more negative (more downward) than the fuselage pitch. In this example, the control surface module 228 may deflect the trailing edge of the stabilator 112, or other control surface 230, downward to alter the fuselage 104 pitch toward the negatively-pitched wing assembly pitch. As depicted in FIGS. 8A and 8B, the difference module 226 may determine that a fuselage pitch is more positive (more upward) than a level wing assembly. In this example, the control surface module 228 may deflect the trailing edge of the stabilator 112, or other control surface 230, downward to alter the fuselage 104 pitch toward the level wing assembly pitch. While particular reference is made to particular initial arrangements with particular differences between a wing assembly pitch and the fuselage pitch and different target arrangements, the control surface control system 102, and the modules 224, 226, and 228 therein may alter the control surface 230 position to set the fuselage pitch to any position based on 1) a detected difference between the fuselage pitch and the wing assembly pitch or 2) a detected difference between the fuselage pitch and a target pitch that is not based on the wing assembly pitch.

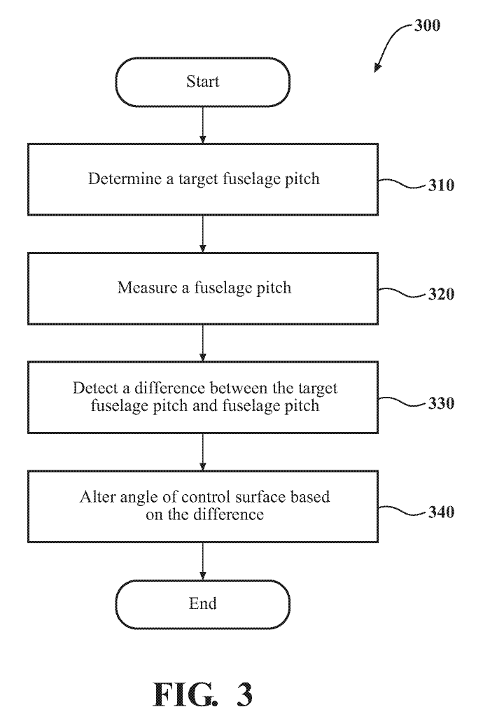

Additional aspects of changing the fuselage pitch in a free-wing or tilt-wing aircraft will be discussed in relation to FIG. 3. Method 300 will be discussed from the perspective of the control surface control system 102 of FIGS. 1 and 2. While method 300 is discussed in combination with the control surface control system 102, it should be appreciated that the method 300 is not limited to being implemented within the control surface control system 102 but is instead one example of a system that may implement the method 300.

At 310, the target pitch module 224 determines a target fuselage pitch for the fuselage 104 of the aircraft 100 where a wing assembly of the aircraft 100 rotates independently from the fuselage 104 about a pitch axis of the aircraft 100. As described above, the target fuselage pitch may be a fixed pitch value, a wing assembly pitch, an offset from a wing assembly pitch, or a pitch that is calculated based on the input objective, which input objective may determine a desired characteristics of the flight (e.g., reduced fuel consumption, reduced drag, low speed flight, etc.).

In general, the difference module 226 determines a difference between the fuselage pitch and the target fuselage pitch calculated by the target pitch module 224. Accordingly, at 320, the difference module 226 measures the fuselage pitch by extracting sensor data 216 indicative of the fuselage pitch. At 330, the difference module 226 determines the difference between this measured value and the target value, whatever that target value may be.

At 340, the control surface module 228 generates a control signal, based on the detected difference, to adjust the control surface 230 angle. In some examples, such an adjustment may be based on the real-time data, i.e., the real-time detected difference, in which case the adjustment may terminate when the measured fuselage pitch matches the target fuselage pitch. In another example, the adjustment may be supplemented by information in the lookup table 218. That is, the control surface module 228 may determine how much to change the control surface position or determine an absolute control surface position based on the detected difference and a mapping between detected differences and control surface position/alteration as indicated in the lookup table 218. In either case, the method 300 facilitates the alteration of control surfaces to align two bodies (i.e., the wing assembly and the fuselage 104), which in free-wing aircraft may have different pitches.

In an example, the control surface control system 102 controls the sensors 232 to acquire the sensor data 216 at successive iterations or time steps. Thus, the control surface control system 102, in one embodiment, iteratively executes the functions discussed at blocks 310-340 to acquire the sensor data 216 and provide information therefrom.

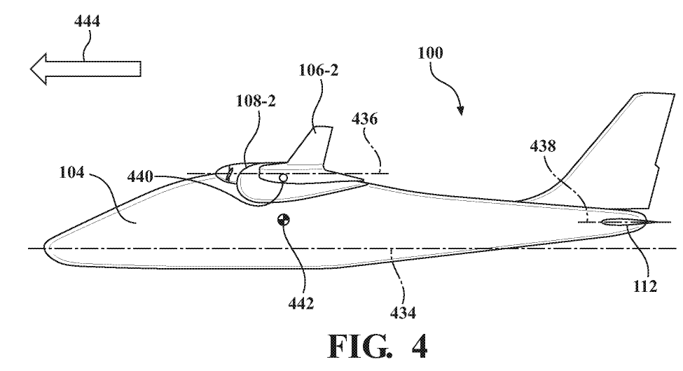

FIG. 4 is a side view of an aircraft 100 with an aligned wing assembly pitch 436 and fuselage pitch 434, according to an embodiment of the principles described herein. Specifically, FIG. 4 depicts the fuselage 104 with the wings 106-1 (not shown) and 106-2 and wing-mounted propellers 108-1 (not shown) and 108-2 and the stabilator 112. As described above, while FIG. 4 and others depict specific thrusters (e.g., propellers) and control surfaces 230 (e.g., stabilator 112), the principles described herein may apply equally to other control surfaces 230 and thruster types.

FIG. 4 also depicts the pitches of the relative components. For example, the fuselage pitch 434, the wing assembly pitch 436, and the stabilator pitch 438. In the example depicted in FIG. 4, the aircraft 100 is flying in a direction 444, and all the pitches 434, 436, and 438 are aligned with one another and generally aligned with the flight direction 444. This may result in an optimal lift and efficiency in some conditions. It may be that this arrangement of the aircraft 100 is the target arrangement, and the fuselage pitch 434 and the wing assembly pitch 436 depicted in FIG. 4 may be the target arrangements to enhance lift and efficiency. However, as depicted in the examples below, it may be that the target condition departs from the depicted arrangement. Accordingly, the control surface control system 102 of the present specification is intended to align the fuselage pitch 434 to achieve the target arrangement depicted in FIG. 4 or a variety of other target arrangements as described herein.

FIG. 4 also depicts the pivot point 440 around which the fuselage 104 and the wings 106-1 and 106-2 rotate in the pitch axis. FIG. 4 also depicts the fuselage center of gravity 442, which in this example is directly below the pivot point 440. However, as described below, the center of gravity 442 may be in front of or behind this pivot point 440, resulting in a nose-down or nose-up fuselage 104 orientation. The control surface control system 102 of the present specification may maintain a target fuselage pitch in either of these conditions (i.e., nose up or nose down).

FIGS. 5A-5B are side views of an aircraft 100 with the fuselage 104 pitched up to match an upwardly-pitched wing assembly, according to an embodiment of the principles described herein. Specifically, as depicted in FIG. 5A, it may be the case that the wing assembly pitch 436 is greater (i.e., more positive relative to a reference line such as an artificial horizon) than the fuselage 104 pitch. The aircraft 100 may be in this configuration when flying at low speed, so the wing assembly may require a high angle of attack to maintain altitude. In this example, the balances of forces and moments on the fuselage 104 may cause the fuselage pitch 434 to be level (i.e., aligned with the reference line, such as an artificial horizon) and lower than that of the wing assembly. As described above, this may reduce the lift of the aircraft 100 and increase the drag, such that operational efficiency is reduced. Note that notwithstanding the wing assembly pitch 436 and the thrust direction, the aircraft 100 may still have the same flight direction 444. That is, when flying at lower speeds, a thrust source may need a greater angle of attack to maintain altitude.

To return the aircraft 100 to an optimized lift and efficiency state, the stabilator 112 trailing edge may be deflected up, altering the stabilator pitch 438 as depicted in FIG. 5B. This generates a downforce on the stabilator 112 and the rear of the fuselage 104. This pitches the fuselage 104 up as depicted in FIG. 5B, such that the fuselage pitch 434 is parallel to the wing assembly pitch 436, which places the aircraft 100 in a more optimized lift and efficiency state. Accordingly, in this example, the control surface control system 102 may operate to 1) determine the target fuselage pitch (e.g., to match the wing assembly pitch 436), 2) measure the wing assembly pitch 436, 3) determine the difference therebetween and adjust the control surface 230 (e.g., stabilator 112) deflection position to align the fuselage pitch 434 with the wing assembly pitch 436. As described above, in an example, the control of the control surface 230 angle may occur until the fuselage pitch 434 matches the wing assembly pitch 436, at which point the control surface control system 102 may terminate control surface adjustments. Note that for purposes of illustration, in FIGS. 5A – 8B, the altered position of the stabilator 112 has been exaggerated to more clearly depict the principles discussed herein.

FIGS. 6A-6B are side views of an aircraft 100 with the fuselage 104 pitched up to match a level wing assembly pitch 436, according to an embodiment of the principles described herein. Specifically, as depicted in FIG. 6A, it may be the case that the fuselage pitch 434 is less (i.e., more negative relative to a reference line such as an artificial horizon) than the wing assembly pitch 436. The aircraft 100 may be in this configuration when the center of gravity 442 of the fuselage 104 is in front of the pivot point 440 of the aircraft 100. This may occur when the payload of the aircraft 100 is more heavily weighted in front of the pivot point 440. In this example, the balances of forces and moments on the fuselage 104 may not alter the wing assembly pitch 436 as the wing assembly and fuselage 104 pivot independently about the pivot point 440. As described above, this may reduce the lift of the aircraft 100 and increase the drag, such that operational efficiency is reduced. Note that notwithstanding the wing assembly pitch 436 and the thrust direction, the aircraft 100 may still have the same flight direction 444.

Notwithstanding this arrangement, the control surface control system 102 may account for a nose-heavy fuselage 104. Specifically, the control surface module 228 may include instructions that cause the processor 220 to alter the angle of the control surface 230 to reduce a negative fuselage pitch responsive to the center of gravity 442 of the fuselage 104 being in front of the pivot point 440 of the aircraft 100.

Specifically, as depicted in FIG. 6B, to return the aircraft 100 to an optimized lift and efficiency state, the stabilator 112 trailing edge may be deflected up, altering the stabilator pitch 438. This generates a downforce on the stabilator 112 and the rear of the fuselage 104. This pitches the fuselage 104 up, such that the fuselage pitch 434 is parallel to the wing assembly pitch 436, which places the aircraft 100 in a more optimized lift and efficiency state. Accordingly, in this example, the control surface control system 102 may operate to 1) determine the target fuselage pitch (e.g., to match the wing assembly pitch 436), 2) measure the wing assembly pitch 436, 3) determine the difference therebetween and adjust the control surface 230 (e.g., stabilator 112) deflection position to align the fuselage pitch 434 with the wing assembly pitch 436. As described above, in an example, the control of the control surface 230 angle may occur until the fuselage pitch 434 matches the wing assembly pitch 436, at which point the control surface control system 102 may terminate control surface adjustments.

FIGS. 7A-7B are side views of an aircraft with the fuselage 104 pitched down to match a downwardly-pitched wing assembly, according to an embodiment of the principles described herein. Specifically, as depicted in FIG. 7A, it may be the case that the wing assembly pitch 436 is less (i.e., more negative relative to a reference line such as an artificial horizon) than the fuselage 104 pitch. The aircraft 100 may be in this configuration when flying at high speed, so the wing assembly may require a low angle of attack to prevent any undesired altitude gain. For example, some wings have a positive camber, which may produce positive lift when the aircraft 100 has zero angle of attack at a predetermined air speed. If the aircraft 100 were to fly at a speed greater than the predetermined air speed, additional lift may be generated, which may cause the aircraft 100 to rise (and therefore not maintain a desired altitude) due to the additional lift generated by the positively cambered wing assembly. Accordingly, in this example, the wing assembly pitch 436 may be negative so that the aircraft maintains altitude (i.e., does not rise) when flying at high speeds.

In this example, the balances of forces and moments on the fuselage 104 may cause the fuselage pitch 434 to be level (i.e., aligned with the reference line, such as an artificial horizon) and higher than that of the wing assembly. As described above, this may increase the drag, such that operational efficiency is reduced. Note that notwithstanding the wing assembly pitch 436 and the thrust direction, the aircraft 100 may still have the same flight direction 444. That is, when flying at higher speeds, a thrust source may need a negative angle of attack to maintain altitude.

To return the aircraft 100 to an optimized lift and efficiency state, the stabilator 112 trailing edge may be deflected down, altering the stabilator pitch 438 as depicted in FIG. 7B. This generates an upward force on the stabilator 112 and the rear of the fuselage 104. This pitches the fuselage 104 down as depicted in FIG. 7B, such that the fuselage pitch 434 is parallel to the wing assembly pitch 436, which places the aircraft 100 in a more optimized lift and efficiency state. Accordingly, in this example, the control surface control system 102 may operate to 1) determine the target fuselage pitch (e.g., to match the wing assembly pitch 436), 2) measure the wing assembly pitch 436, 3) determine the difference therebetween and adjust the control surface 230 (e.g., stabilator 112) deflection position to align the fuselage pitch 434 with the wing assembly pitch 436. As described above, in an example, the control of the control surface 230 angle may occur until the fuselage pitch 434 matches the wing assembly pitch 436, at which point the control surface control system 102 may terminate control surface adjustments.

FIG. 8A-8B are side views of an aircraft 100 with the fuselage 104 pitched down to match a wing assembly pitch 436, according to an embodiment of the principles described herein. Specifically, as depicted in FIG. 8A, it may be the case that the fuselage pitch 434 is greater (i.e., more positive relative to a reference line such as an artificial horizon) than the wing assembly pitch 436. The aircraft 100 may be in this configuration when the center of gravity 442 of the fuselage 104 is behind the pivot point 440 of the aircraft 100. This may occur when the payload of the aircraft 100 is more heavily weighted behind the pivot point 440. In this example, the balances of forces and moments on the fuselage 104 may not alter the wing assembly pitch 436 as the wing assembly and fuselage 104 pivot independently about the pivot point 440. As described above, this may increase the drag of the aircraft 100, such that operational efficiency is reduced. Note that notwithstanding the wing assembly pitch 436 and the thrust direction, the aircraft 100 may still have the same flight direction 444.

Notwithstanding this arrangement, the control surface control system 102 may account for a tail-heavy fuselage 104. Specifically, the control surface module 228 may include instructions that cause the processor 220 to alter the angle of the control surface 230 to reduce a positive fuselage pitch responsive to the center of gravity 442 of the fuselage 104 being behind the pivot point 440 of the aircraft 100.

Specifically, as depicted in FIG. 8B, to return the aircraft 100 to an optimized lift and efficiency state, the stabilator 112 trailing edge may be deflected down, altering the stabilator pitch 438. This generates an upward force on the stabilator 112 and the rear of the fuselage 104. This pitches the fuselage 104 down, such that the fuselage pitch 434 is parallel to the wing assembly pitch 436, which places the aircraft 100 in a more optimized lift and efficiency state. Accordingly, in this example, the control surface control system 102 may operate to 1) determine the target fuselage pitch (e.g., to match the wing assembly pitch 436), 2) measure the wing assembly pitch 436, 3) determine the difference therebetween and adjust the control surface 230 (e.g., stabilator 112) deflection position to align the fuselage pitch 434 with the wing assembly pitch 436. As described above, in an example, the control of the control surface 230 angle may occur until the fuselage pitch 434 matches the wing assembly pitch 436, at which point the control surface control system 102 may terminate control surface adjustments.

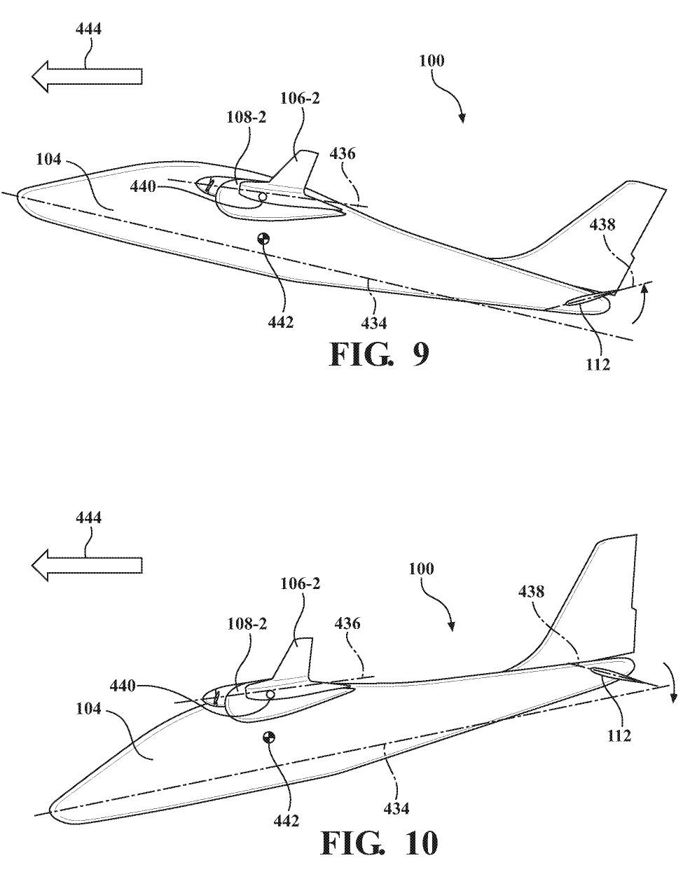

FIG. 9 is a side view of an aircraft 100 where the fuselage 104 and wing assembly are upwardly-pitched to different degrees, according to an embodiment of the principles described herein. That is, it may be the case that having a fuselage pitch 434 parallel to the wing assembly pitch 436 may not maximize the operational efficiency of the aircraft 100. That is, various factors determine a desired or optimum aircraft efficiency. Example factors include the overall lift efficiency due to the fuselage pitch 434, the pressure drag of the fuselage 104, which increases with angle of attack, and the lift (or downforce) and drag of the stabilator 112 deflection that achieves the target fuselage pitch.

For example, it may be that there is a structure, such as a rear-facing window of the aircraft 100, which causes airflow separation behind the rear canopy that causes drag. Because of this geometry, if the aircraft 100 is flying with a wing assembly pitch 436 of 5º degrees, it may be that setting the fuselage pitch 434 to 5º may result in more drag than if the fuselage pitch 434 were set to 3º. Accordingly, in this example, the control surface control system 102 may alter the fuselage pitch 434 to be different than the wing assembly pitch 436 to reduce drag.

Another example is that the stabilator 112 deflection may similarly create drag, such that an aligned fuselage pitch 434 and wing assembly pitch 436 may not result in the lowest overall drag. Similar to the example above, in this example, the control surface control system 102 may alter the fuselage pitch 434 to be misaligned from the wing assembly pitch 436 to achieve a reduced drag, improved lift, and overall efficiency. While particular reference is made to particular factors that may trigger misaligned fuselage pitch 434 and wing assembly pitch 436, different factors may similarly trigger misaligned pitches. Accordingly, the combination of these factors should be considered when controlling the fuselage pitch.

In these examples, the control surface control system 102 may determine the target fuselage pitch in real-time by monitoring sensor data 216 indicative of a particular condition and altering the fuselage pitch 434 until the sensor data 216 aligns with the objective. In other words, the target fuselage pitch may be determined in real-time by processing the sensor data 216 to find when a metric associated with the input objective is minimized or when the input objective is achieved. For example, the aircraft 100 may include fuel sensors that measure aircraft 100 fuel levels and/or consumption and that indirectly indicate the drag on the aircraft 100. That is, greater fuel consumption rates correlate to increased drag. Accordingly, the aircraft 100 may monitor fuel consumption and identify the optimized drag state where the least fuel is consumed. Specifically, the control surface control system 102 may monitor fuel consumption and continually adjust the control surface 230 deflection (resulting in a change to the fuselage pitch 434) until the fuel consumption or fuel usage rate is at a minimum. This is an example of relying on a minimum value for a metric to determine the target fuselage pitch. Accordingly, the control surface control system 102 may set the target fuselage pitch as that pitch that results in the fuel consumption being minimized. An example of a control loop for this scenario is depicted in FIG. 14 below.

In an example where a target lift mode is selected (i.e., a target aerodynamic condition), the control surface control system 102 may calculate a lift of the aircraft 100 by monitoring such sensors 232 such as an angle of attack sensor, a pitot tube, a static port, a vertical accelerometer, a strain guage, or flight data computers and processing this sensor data. In this example, the control surface control system 102 may adjust the control surface 230 deflection (resulting in a change to the fuselage pitch 434) until the calculated lift matches the target lift value indicated by the pilot. This is an example of relying on the input objective to determine the target fuselage pitch.

Accordingly, in both these examples, rather than setting the target fuselage pitch to the wing assembly pitch 436, the control surface control system 102 may define the target fuselage pitch by some additional sensor data 216 value. Note that this target fuselage pitch may adjust as flight conditions change. In these examples, the control surface control system 102 may monitor, based on the input objective, a metric associated with the input objective and select as the target fuselage pitch, a fuselage pitch 434 that results in the metric being at least one of a maximum value, a minimum value, or another predetermined value. That is, the control surface control system 102 may alter the angle of the control surface 230 until the metric is minimized, maximized, or met. The control surface control system 102 may then set the pitch which results in the metric being minimized, maximized, or met as the target fuselage pitch.

FIG. 9 depicts an example of such a scenario where the fuselage pitch 434 is more positive than the wing assembly pitch 436. The wing assembly angle of attack and the lift generated therefrom may be limited by aerodynamic stall. That is, if the wings 106-1 and 106-2 are pitched to too great a degree relative to the direction of airflow, the airflow may pull away from the contours of the wings 106-1 and 106-2, thus reducing the lift generated by the wings 106-1 and 106-2. The fuselage 104, by comparison, may be able to sustain much higher angles of attack before loss of lift. Accordingly, if the pilot desires a greater lift than can be provided by the wing assembly without resulting in a wing stall, the stabilator 112, or other control surface 230, may be deflected such that the fuselage pitch 434 is greater than the wing assembly pitch 436, thus generating the additional desired lift. Providing the additional lift via fuselage pitch increase may increase the drag on the aircraft 100, which may be acceptable given the desired flight environment. A pilot may desire this non-parallel, positively pitched configuration of the wing assembly and the fuselage when flying the aircraft 100 at low speeds or high bank angles. In an example, 1) the difference between the fuselage pitch 434 and the wing assembly pitch 436 or 2) the target fuselage pitch may be defined in the lookup table 218 and indexed by the speed of the aircraft 100. An example of a control loop for this scenario is depicted in FIG. 15 below.

FIG. 10, by comparison, is a side view of an aircraft 100 where the fuselage 104 and wing assembly are downwardly-pitched to different degrees, according to an embodiment of the principles described herein. As described above in regards to FIGS. 7A and 7B, for various reasons, it may be desired to operate the aircraft 100 with a negative wing assembly pitch 436, for example, to provide negative lift, and offset any positive lift generated by a positively-cambered wing assembly. However, as with the example depicted in FIG. 9, a wing stall may occur if the wing assembly is negatively pitched too much. Accordingly, as with the example depicted in FIG. 10, the control surface control system 102 may deflect the trailing edge of the stabilator 112 down, which further pitches the fuselage 104 down so that the fuselage pitch 434 is less than the wing assembly pitch 436. Thus providing the additional negative lift.

As another example, pitching the fuselage 104 up or down as depicted in FIGS. 9 and 10 may allow the aircraft 100 to decelerate more quickly. That is, as described above, the misalignment of the wing assembly pitch 436 and the fuselage pitch 434 may increase drag. Accordingly, the fuselage 104 may act as an airbrake to slow the aircraft 100 down more quickly than would otherwise be possible. In this example, the pilot may enable the misaligned fuselage and wing assembly pitches and/or define an amount of allowed difference by selecting a mode of the aircraft that facilitates the advanced maneuvers (i.e., rapid deceleration). In another example, the pilot may select a desired level of negative lift or a desired altitude, and the control surface control system 102 may automatically adjust the target fuselage pitch when the desired level of negative lift or altitude is not maintained by movement of the wing assembly alone.

Note that the intent to have the wing assembly and fuselage 104 pitched to different degrees may be based on the input objective, which may be determined via pilot selection. For example, a pilot may select a particular “mode” of an aircraft 100, such as an aerobatic mode, where more advanced maneuvers (i.e., greater lift and greater speed) are permitted and the fuselage 104 is pitched to facilitate those advanced maneuvers. As another example, the pilot may select a desired level of lift, and the control surface control system 102 may automatically adjust the target fuselage pitch when the desired level of lift is not achieved by movement of the wing assembly alone.

In these examples, the control surface module 228 may include instructions that cause the processor to alter the fuselage control surface 230 pitch to reduce the detected difference between the fuselage pitch 434 and the wing assembly pitch 436. In specific examples, the control surface module 2281) may alter the angle of the control surface 230 such that the fuselage pitch 434 is more positively pitched than the wing assembly as depicted in FIG. 9 or 2) may alter the angle of the control surface 230 such that the fuselage pitch is more negatively pitched than the wing assembly as depicted in FIG. 10.

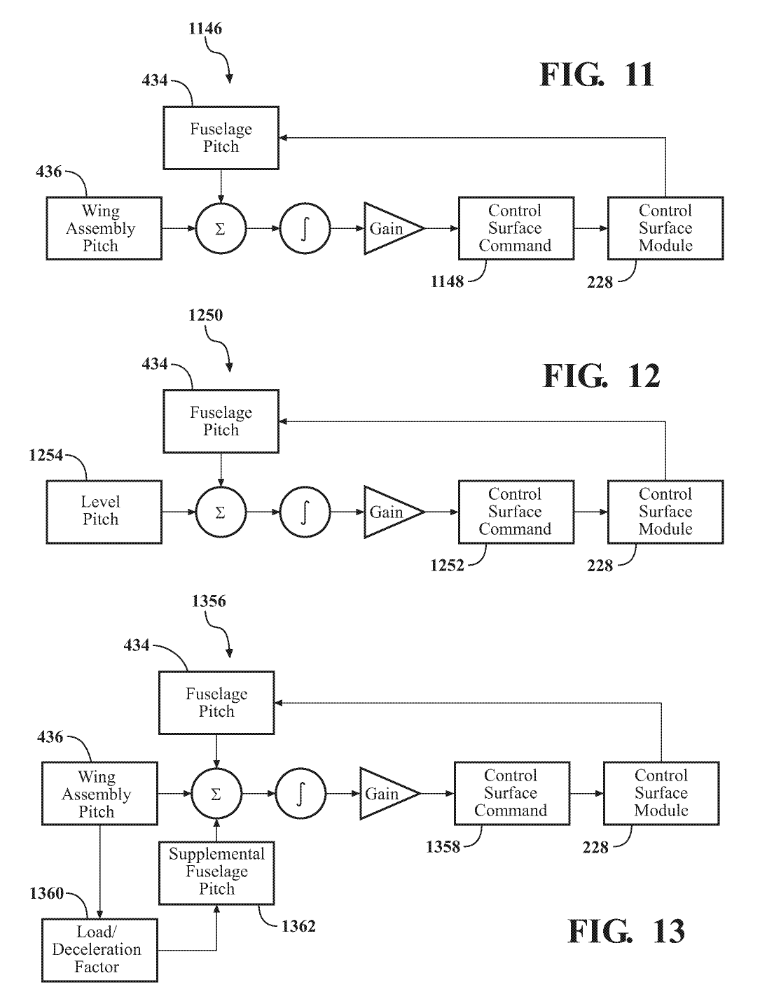

FIG. 11 depicts a control loop 1146 that aligns the fuselage pitch 434 with a wing assembly pitch 436, according to an embodiment of the principles described herein. As described above, for a free-wing aircraft 100, the wing assembly pitch 436 may differ from the fuselage pitch 434, leading to an undesirable and sub-optimal lift condition. Accordingly, per the example control loop depicted in FIG. 11, the control surface control system 102 may alter the control surface 230 position to align the fuselage pitch 434 to the wing assembly pitch 436.

As described above, the aircraft 100 may include sensors 232 that sense the actual, or measured, pitch of the wing assembly and of the fuselage 104. In this example, the difference module 226 sums (e.g., “∑”) measured values of the wing assembly pitch 436 and the fuselage pitch 434. The summation indicates a difference between the two.

In an example, the difference may be converted into a control surface command 1148, which is a command signal for the various control surface system components to operate in a way to place the control surface 230 at a position to set the fuselage pitch 434 to match the wing assembly pitch 436. That is, to effect the fuselage attitude control, the control surface module 228 actuates a variety of actuators, servos, potentiometers, etc., to physically move the control surface 230. The control surface command 1148 generates electrical signals for each of these components to operate in a way that physically moves the control surface 230 to achieve a desired pitch change in the fuselage 104.

The control surface command 1148 may be defined by the size of the difference. For example, when the fuselage pitch 434 matches the wing assembly pitch 436, no control surface command 1148 may be generated. As the difference between the two increases, the control surface command 1148 may be altered to coincide with the degree of difference.

In the example depicted in FIG. 11, the control loop 1146 prescribes a smoothing function. For example, the difference between a fuselage pitch 434 and a wing assembly pitch 436 may be attributable to the control surface module 228 responding, albeit lagging, to a detected difference. Accordingly, rather than adjusting the control surface angle when the difference is greater than a predetermined amount, which may result in superfluous adjustments and/or jerky flight control, the control surface module 228 may adjust the control surface 230 when the difference is greater than a predetermined amount for a predetermined time. That is, the difference module 226 may include instructions that cause the processor 220 to detect a time-dependent difference between the fuselage pitch 434 and the wing assembly pitch 436. This smoothing out may eliminate steady-state angular error and may be less prone to oscillation than a proportional control.

In the example depicted in FIG. 11, a time-dependent summation is calculated by integrating (e.g., ∫) the summation of the difference between the fuselage pitch 434 and the wing assembly pitch 436. In some examples, the integrated difference is subjected to processing, filtering, or other conditioning (e.g., “gain”) to enhance the difference signal. The smoothed difference signal may be converted into the control surface command 1148 and transmitted to the control surface module 228.

Note that while FIG. 11, and others, depicts integration as one mechanism for generating a time-dependent difference; other smoothing mechanisms may be employed, such as ramps, filters, IIR filters, delays, proportional filters, linear-quadratic regulators (LQRs), model predictive control (MPC), extended Kálmán filters (EKF), artificial neural networks (ANN), or any other controller.

FIG. 12 depicts a control loop 1250 that aligns the fuselage pitch 434 with a predetermined pitch, according to an embodiment of the principles described herein. As described above, in some situations, it may be desirable to align the fuselage pitch 434 with a level pitch 1254, such as an artificial horizon, regardless of the wing assembly pitch 436. This may provide low-drag flight conditions or help keep certain fuselage-mounted sensors level.

Accordingly, per the example control loop 1250 depicted in FIG. 12, the control surface control system 102 may alter the control surface 230 position to align the fuselage pitch 434 to the predetermined pitch. That is, the target fuselage pitch may be a fixed value, and the control surface control system 102 may include instructions that alter the angle of the control surface 230 so that the fuselage pitch 434 matches the fixed value.

As in the previous example, the difference module module 226 sums (e.g., “∑”) the measured fuselage pitch 434 and the level pitch 1254 value. The summation indicates a difference between the two.

In the example depicted in FIG. 12, the control loop 1250 prescribes a smoothing function. Accordingly, rather than adjusting the control surface 230 when the difference is greater than a predetermined amount, the control surface module 228 may adjust the control surface 230 when the difference is greater than a predetermined amount for a predetermined time. In the example depicted in FIG. 12, a time-dependent summation is calculated by integrating (e.g., ∫) the summation of the difference between the fuselage pitch 434 and the level pitch 1254. That is, the difference module 226 may include instructions that cause the processor 220 to detect a time-dependent difference between the fuselage pitch 434 and the level pitch 1254. This smoothing out may eliminate steady-state angular error and may be less prone to oscillation than a proportional control.

In some examples, the integrated difference is subjected to processing, filtering, or other conditioning (e.g., “gain”) to enhance the difference signal. The smoothed difference signal may be converted into the control surface command 1252 and transmitted to the control surface module 228.

As in the above case, the control surface command 1252 may be defined by the size of the difference. For example, when the fuselage pitch 434 matches the level pitch 1254, no control surface command 1252 may be generated. As the difference between the two increases, the control surface command 1252 may be altered to coincide with the degree of difference.

FIG. 13 depicts a control loop 1356 that adjusts the fuselage pitch 434 towards a wing assembly pitch 436, but with an offset, according to an embodiment of the principles described herein. That is, in the example depicted in FIG. 13, it may be desirable to pitch the fuselage 104 higher or lower than the wing assembly. As described above, this misaligned pitch configuration may provide for increased positive or negative lift (referred to as load factor or vertical Gs) above what may be provided by a wing assembly or may provide extra deceleration due to drag. Accordingly, a user may set a desired load/deceleration factor 1360, and the control surface control system 102 may determine how the fuselage 104 should be pitched to provide the desired load or if increasing the fuselage pitch 434 would increase the drag to accommodate the desired deceleration rate. Either of these selections could be mapped to a supplemental fuselage pitch 1362 value.

As in the previous example, the difference module 226 sums (e.g., “∑”) the wing assembly pitch 436, the fuselage pitch 434, and the supplemental fuselage pitch 1362, which may be defined by the aircraft load/deceleration factor 1360.

In the example depicted in FIG. 13, the control loop 1356 prescribes a smoothing function. Accordingly, rather than adjusting the control surface 230 when the difference is greater than a predetermined amount, the control surface module 228 may adjust the control surface 230 when the difference is greater than a predetermined amount for a predetermined time. In the example depicted in FIG. 13, a time-dependent summation is calculated by integrating (e.g., ∫) the summation of the difference between the fuselage pitch 434, the wing assembly pitch 436, and the supplemental fuselage pitch 1362. That is, the difference module 226 may include instructions that cause the processor 220 to detect a time-dependent difference between the fuselage pitch 434, the wing assembly pitch 436, and a supplemental fuselage pitch 1362 amount defined by the desired aircraft load/deceleration factor 1360. This smoothing out may eliminate steady-state angular error and may be less prone to oscillation than a proportional control.

In some examples, the integrated difference is subjected to processing, filtering, or other conditioning (e.g., “gain”) to enhance the difference signal. The smoothed difference signal may be converted into the control surface command 1358 and transmitted to the control surface module 228.

As in the above case, the control surface command 1358 may be defined by the size of the difference. As the difference between the values increases, the control surface command 1358 may be altered to coincide with the degree of difference.

FIG. 14 depicts a control loop 1464 that adjusts the fuselage pitch 434 to achieve a target energy consumption, according to an embodiment of the principles described herein. As described above, rather than being based on a wing assembly pitch 436, in some examples, the control surface 230 adjustments may be based on another type of target fuselage pitch, one that is indirectly calculated based on an input objective. For example, a pilot may input a target “mode” (e.g., an energy consumption mode) for the aircraft 100, where the target fuselage pitch 1470 is adjusted to achieve a particular goal. In the example depicted in FIG. 14, the fuselage pitch 434 is adjusted to actively achieve a target energy consumption, e.g., a minimal battery current or fuel flow. In the example depicted in FIG. 14, the control loop 1464 utilizes a derivative (i.e., δ) of energy consumption to determine the target fuselage pitch 1470. Accordingly, the control surface control system 102 may alter the control surface 230 position to align the fuselage pitch 434 with a target fuselage pitch 1470 that is associated with a fuselage pitch where energy consumption matches a target value, such as a minimum value. In general, the derivative converges at a point where the rate of change of energy versus fuselage pitch 434 is zero, which may indicate that target energy consumption (e.g., the minimum energy consumption) is achieved. In some examples, the derivative may be subjected to processing, filtering, or other conditioning (e.g., “gain”) to enhance the difference signal.

In the control loop 1464, the difference module 226 sums (e.g., “∑”) the target fuselage pitch 1470 and the fuselage pitch 434. The summation indicates a difference between the two. In an example, the difference may be converted into a control surface command 1468, which is a command signal for the various control surface system components to operate in a way to place the control surface 230 at a position to reduce the energy consumption of the aircraft 100. That is, to effect the fuselage attitude control, a control surface module 228 actuates a variety of actuators, servos, potentiometers, etc., to physically move the control surface 230. The control surface command 1468 generates electrical signals for each of these components to operate in a way that physically moves the control surface 230 to achieve a desired pitch change in the fuselage 104.

The control surface command 1468 may be defined by the size of the difference. For example, when the fuselage pitch 434 matches the target fuselage pitch 1470, no control surface command 1468 may be generated. As the difference between the two increases, the control surface command 1468 may be altered to coincide with the degree of difference.

In the example depicted in FIG. 14, the control surface control loop 1464 prescribes a smoothing function. For example, the difference between a fuselage pitch 434 and the target fuselage pitch 1470 may be attributable to the control surface module 228 responding, albeit lagging, to a detected difference. Accordingly, rather than adjusting the control surface angle when the difference is greater than a predetermined amount, which may result in superfluous adjustments and/or jerky flight control, the control surface module 228 may adjust the control surface 230 when the difference is greater than a predetermined amount for a predetermined time. That is, the difference module 226 may include instructions that cause the processor 220 to detect a time-dependent difference between the fuselage pitch 434 and the target fuselage pitch 1470. This smoothing out may eliminate steady-state angular error and may be less prone to oscillation than a proportional control.

In the example depicted in FIG. 14, a time-dependent summation is calculated by integrating (e.g., ∫) the summation of the difference between the fuselage pitch 434 and the target fuselage pitch 1470. In some examples, the integrated difference is subjected to processing, filtering, or other conditioning (e.g., “gain”) to enhance the difference signal. The smoothed difference signal may be converted into the control surface command 1468 and transmitted to the control surface module 228.

FIG. 15 depicts a control loop 1576 that aligns the fuselage pitch with a predetermined pitch, according to an embodiment of the principles described herein. In the example depicted in FIG. 15, the target fuselage pitch 1582 can be prescribed a priori based on a variety of measurable factors 1580 such as airspeed, altitude, wing assembly pitch, uncompensated fuselage attitude, and a required surface deflection. In other words, as described above, the target fuselage pitch 1582 may be determined based on information included in a lookup table 218. That is, the lookup table 218 may map the various measurable factors 1580, such as airspeed, altitude, wing assembly pitch, uncompensated fuselage attitude, and the required surface deflection to a target fuselage pitch 1582. While reference is made to specific measurable factors 1580, the control surface control system 102 may map any, or multiple, of these measurable factors 1580 and other measurable factors to a target fuselage pitch 1582.

From there, the control surface control system 102 executes the control loop 1576 as described above. Specifically, the difference module module 226 sums (e.g., “∑”) the lookup table based target fuselage pitch 1582 and the fuselage pitch 434. The summation indicates a difference between the two.

In the example depicted in FIG. 15, the control loop 1576 prescribes a smoothing function. Accordingly, rather than adjusting the control surface 230 when the difference is greater than a predetermined amount, the control surface module 228 may adjust the control surface 230 when the difference is greater than a predetermined amount for a predetermined time. In the example depicted in FIG. 15, a time-dependent summation is calculated by integrating (e.g., ∫) the summation of the difference between the fuselage pitch 434 and the lookup table-based target fuselage pitch 1582. That is, the difference module 226 may include instructions that cause the processor 220 to detect a time-dependent difference between the fuselage pitch 434 and the lookup table-based target fuselage pitch 1582. This smoothing out may eliminate steady-state angular error and may be less prone to oscillation than a proportional control.

In some examples, the integrated difference is subjected to processing, filtering, or other conditioning (e.g., “gain”) to enhance the difference signal. The smoothed difference signal may be converted into the control surface command 1578 and transmitted to the control surface module 228.

As in the above case, the control surface command 1578 may be defined by the size of the difference. For example, when the fuselage pitch 434 matches the lookup table-based target fuselage pitch 1582, no control surface command 1578 may be generated. As the difference between the two increases, the control surface command 1578 may be altered to coincide with the degree of difference.

Note that while FIGS. 11-15 depict specific examples of control loops, a variety of different control structures may be implemented in accordance with the principles described herein.

As such, the present control surface control system 102 enhances the lift and operational efficiency of a free-wing aircraft 100 by adjusting control surfaces 230 based on a difference between the fuselage pitch 434 and a target fuselage pitch, which target fuselage pitch may be defined by the wing assembly pitch 436 or some other input objective.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-15, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components, and/or processes also can be embedded in a machine-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and which, when loaded in a processing system, is able to carry out these methods.

Furthermore, arrangements described herein may take the form of a computer program product embodied in one or more machine-readable media having machine-readable program code embodied, e.g., stored, thereon. Any combination of one or more machine-readable media may be utilized. The phrase “machine-readable storage medium” means a non-transitory storage medium. A machine-readable storage medium may be, for example, but not limited to, an electronic, magnetic, optical, electromagnetic, infrared, or semiconductor system, apparatus, or device, or any suitable combination of the foregoing. A non-exhaustive list of the machine-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a machine-readable storage medium is, for example, a tangible medium that stores a program for use by or in connection with an instruction execution system, apparatus, or device.

Program code embodied on a machine-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of … and ….” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
determine, based on an input objective, a target fuselage pitch for a fuselage of an aircraft, a wing assembly of the aircraft rotates about a pitch axis of the aircraft independently from the fuselage;
measure a fuselage pitch of the fuselage; and
alter an angle of a control surface of the fuselage based on a difference between the target fuselage pitch and the fuselage pitch.

2. The system of claim 1, wherein:
the machine-readable instruction that causes the processor to determine the target fuselage pitch comprises a machine-readable instruction that causes the processor to determine the target fuselage pitch based on a wing assembly pitch;
the memory further comprises machine-readable instructions that, when executed by the processor, cause the processor to:
measure the wing assembly pitch; and
detect a difference between the fuselage pitch and the wing assembly pitch; and
the machine-readable instruction that causes the processor to alter the angle of the control surface comprises a machine-readable instruction that causes the processor to alter the angle of the control surface based on a detected difference between the fuselage pitch and the wing assembly pitch.

3. The system of claim 2, wherein the machine-readable instruction that causes the processor to alter the angle of the control surface based on the detected difference comprises a machine-readable instruction that causes the processor to alter the angle of the control surface so the fuselage pitch matches the wing assembly pitch.

4. The system of claim 2, wherein the machine-readable instruction that causes the processor to alter the angle of the control surface based on the detected difference comprises at least one of:
a machine-readable instruction that causes the processor to alter the angle of the control surface so the fuselage pitch is more positively pitched than the wing assembly; or
a machine-readable instruction that causes the processor to alter the angle of the control surface such that the fuselage pitch is more negatively pitched than the wing assembly.

5. The system of claim 2, wherein the machine-readable instruction that causes the processor to alter the angle of the control surface based on the detected difference comprises a machine-readable instruction that causes the processor to alter the angle of the control surface to reduce the detected difference between the fuselage pitch and the wing assembly pitch.

6. The system of claim 2, wherein:
the memory further comprises a machine-readable instruction that, when executed by the processor, causes the processor to determine, based on the input objective, a target difference between the fuselage pitch and the wing assembly pitch; and
the machine-readable instruction that causes the processor to alter the angle of the control surface comprises a machine-readable instruction that causes the processor to alter the angle of the control surface based on the target difference.

7. The system of claim 2, further comprising a lookup table that maps control surface angle adjustments to the detected difference between the fuselage pitch and the wing assembly pitch.

8. The system of claim 1, wherein the memory further comprises machine-readable instructions that, when executed by the processor, cause the processor to:
monitor a metric indicative of a state of the input objective; and
select, as the target fuselage pitch, the fuselage pitch that results in the metric being at least one of a maximum value, a minimum value, or a predetermined value.

9. The system of claim 1, wherein the memory further comprises a machine-readable instruction that, when executed by the processor, causes the processor to identify the input objective based on user selection of the input objective from a set of candidate objectives.

10. The system of claim 1, wherein:
the target fuselage pitch is a fixed value; and
the machine-readable instruction that causes the processor to alter the angle of the control surface comprises a machine-readable instruction that causes the processor to alter the angle of the control surface so that the fuselage pitch matches the fixed value.

11. The system of claim 1, wherein the input objective is at least one of:
a target energy consumption;
a target range; or
a target aerodynamic condition.

12. The system of claim 1, wherein the machine-readable instruction that causes the processor to alter the angle of the control surface of the fuselage comprises at least one of:
a machine-readable instruction that causes the processor to alter the angle of the control surface to reduce a negative fuselage pitch, responsive to a center of gravity of the fuselage being in front of a pivot point of the fuselage; or
a machine-readable instruction that causes the processor to alter the angle of the control surface to reduce a positive fuselage pitch, responsive to the center of gravity of the fuselage being behind the pivot point of the fuselage.

13. A non-transitory machine-readable medium comprising instructions that, when executed by a processor, cause the processor to:
determine, based on an input objective, a target fuselage pitch for a fuselage of an aircraft, a wing assembly of the aircraft rotates about a pitch axis of the aircraft independently from the fuselage;
measure a fuselage pitch of the fuselage; and
alter an angle of a control surface of the fuselage based on a difference between the target fuselage pitch and the fuselage pitch.

14. The non-transitory machine-readable medium of claim 13, wherein:
the instruction that causes the processor to determine the target fuselage pitch comprises an instruction that causes the processor to determine the target fuselage pitch based on a wing assembly pitch;
the instructions further comprise instructions that, when executed by the processor, cause the processor to:
measure the wing assembly pitch; and
detect a difference between the fuselage pitch and the wing assembly pitch; and
the instruction that causes the processor to alter the angle of the control surface comprises an instruction that causes the processor to alter the angle of the control surface based on a detected difference between the fuselage pitch and the wing assembly pitch.

15. The non-transitory machine-readable medium of claim 14, wherein the instruction that causes the processor to alter the angle of the control surface based on the detected difference comprises at least one of:
an instruction that causes the processor to alter the angle of the control surface so the fuselage pitch matches the wing assembly pitch;
an instruction that causes the processor to alter the angle of the control surface to reduce the detected difference between the fuselage pitch and the wing assembly pitch;
an instruction that causes the processor to alter the angle of the control surface so the fuselage pitch is more positively pitched than the wing assembly; or
an instruction that causes the processor to alter the angle of the control surface so the fuselage pitch is more negatively pitched than the wing assembly.

16. The non-transitory machine-readable medium of claim 14, wherein:
the instructions further comprise an instruction that, when executed by the processor, causes the processor to determine, based on the input objective, a target difference between the fuselage pitch and the wing assembly pitch; and
the instruction that causes the processor to alter the angle of the control surface comprises an instruction that causes the processor to alter the angle of the control surface based on the target difference.

17. A method, comprising:
determining, based on an input objective, a target fuselage pitch for a fuselage of an aircraft, a wing assembly of the aircraft rotates about a pitch axis of the aircraft independently from the fuselage;
measuring a fuselage pitch of the fuselage; and
altering an angle of a control surface of the aircraft based on a difference between the target fuselage pitch and the fuselage pitch.

18. The method of claim 17, wherein:
determining the target fuselage pitch comprises determining the target fuselage pitch based on a wing assembly pitch;
the method further comprises:
measuring the wing assembly pitch; and
detecting a difference between the fuselage pitch and the wing assembly pitch; and
altering the angle of the control surface comprises altering the angle of the control surface based on a detected difference between the fuselage pitch and the wing assembly pitch.

19. The method of claim 18, wherein altering the angle of the control surface based on the detected difference comprises at least one of:
altering the angle of the control surface so the fuselage pitch matches the wing assembly pitch;
altering the angle of the control surface to reduce the detected difference between the fuselage pitch and the wing assembly pitch;
altering the angle of the control surface such that the fuselage pitch is more positively pitched than the wing assembly; or
altering the angle of the control surface such that the fuselage pitch is more negatively pitched than the wing assembly.

20. The method of claim 18, wherein:
the method further comprises determining, based on the input objective, a target difference between the fuselage pitch and the wing assembly pitch; and
altering the angle of the control surface comprises altering the angle of the control surface based on the target difference.
